(19) United States
(12) Patent Application Publication
(10) Pub. No.: US 2022/0381280 A1
(43) Pub. Date: Dec. 1, 2022

(54) Fastener

(71) Applicants: Linton Robert Lounds, Whitby (CA); Carlis Lounds, Whitby (CA)

(72) Inventors: Linton Robert Lounds, Whitby (CA); Carlis Lounds, Whitby (CA)

(21) Appl. No.: 17/334,906

(22) Filed: May 31, 2021

(51) Int. Cl. F16B 25/00; F16B 23/00

(52) U.S. Cl. CPC F16B 25/0015; F16B 25/0063; F16B 23/0038

(57) ABSTRACT

A fastener includes a screw structure having threads and a dowel structure. The dowel structure includes a shank extending from the screw structure in an axial direction and connected to the screw structure, and a head engaged to the shank portion and disposed distally from the screw structure. A length of the dowel structure is greater than or equal to a length of the screw structure.

### TECHNICAL FIELD

The present disclosure relates to a fastener. More particularly, the present disclosure pertains to a fastener suitable for mounting a floating shelf to a wall.

### BACKGROUND

Floating shelves, floating mantles, or other floating objects appear to be floating on a wall and are supported by mounts strong enough to support significant weight. However, for mounting the floating shelves on the wall, a plurality of connecting elements such as brackets, extensions, metal strips, clips, and covers are used. The plurality of connecting elements is linked in a way to facilitate non-visibility of the connecting elements to an observer. However, the installation process is complex due to the engagement of multiple parts and requires specialized tools and process. In addition, the multiple connecting elements increases the overall cost of installation.

### SUMMARY

According to an aspect of the disclosure, a fastener is disclosed. The fastener includes a screw structure having threads, and a dowel structure. The dowel structure includes a shank extending from the screw structure in an axial direction and connected to the screw structure and a head engaged to the shank and disposed distally from the screw structure. A length of the dowel structure is greater than or equal to a length of the screw structure.

In an embodiment, the head is a hexagonal head to facilitate an engagement of a torque driver to the fastener.

In an embodiment, the screw structure is a wood screw.

In an embodiment, the threads are unified national coarse threads.

In an embodiment, the length of the screw structure is between 2 inches and 2.5 inches.

In an embodiment, the length of the dowel structure is between 3.5 inches and 5 inches.

In an embodiment, the fastener is made of steel.

In an embodiment, a diameter of the dowel structure is between 3/16 inches and 0.5 inches.

According to an aspect of the disclosure, a method for mounting a shelf to a wall is disclosed. The method includes providing a fastener including a screw structure having threads and a dowel structure. The dowel structure includes a shank extending from the screw structure in an axial direction and connected to the screw structure, and a head engaged to the shank and disposed distally from the screw structure. A length of the dowel structure is greater than or equal to a length of the screw structure. Further, the method includes inserting the screw structure inside the wall, forming a hole inside the shelf, and inserting the dowel structure inside the hole to engage the shelf to the wall.

In an embodiment, inserting the dowel structure inside the hole includes snug fitting the dowel structure inside the hole.

In an embodiment, the dowel structure is adhesively attached to the shelf.

In an embodiment, a diameter of the hole is equal to a diameter of the dowel structure.

In an embodiment, the head is a hexagonal head to facilitate an engagement of a torque driver to the fastener to enable the insertion of the screw structure inside the wall.

In an embodiment, the screw structure is a wood screw.

In an embodiment, the threads are unified national coarse threads.

In an embodiment, the length of the screw structure is between 2 inches and 2.5 inches.

In an embodiment, the length of the dowel structure is between 3.5 inches and 5 inches.

In an embodiment, a diameter of the dowel structure is between 3/16 inches and 0.5 inches.

According to an aspect of the disclosure, a fastener including a screw structure and a dowel structure is disclosed. The screw structure is a wood screw having unified national coarse threads. The dowel structure includes a shank extending from the screw structure in an axial direction and connected to the screw structure, and a hexagonal head engaged to the shank and disposed distally from the screw structure. The hexagonal head facilitates an engagement of a torque driver to the fastener. A length of the dowel structure is greater than or equal to a length of the screw structure.

In an embodiment, the length of the screw structure is between 2 inches and 2.5 inches and the length of the dowel structure is between 3.5 inches and 5 inches.

For a more complete understanding of the present invention, reference is made to the following detailed description and accompanying drawings. In the drawing, like reference characters refer to like parts throughout the views.

### BRIEF DESCRIPTION OF THE DRAWINGS

FIG. 1 illustrates a fastener, in accordance with an embodiment of the disclosure; and

FIG. 2 illustrates a floating shelf mounting to a wall using the fastener, in accordance with an embodiment of the disclosure.

### DETAILED DESCRIPTION

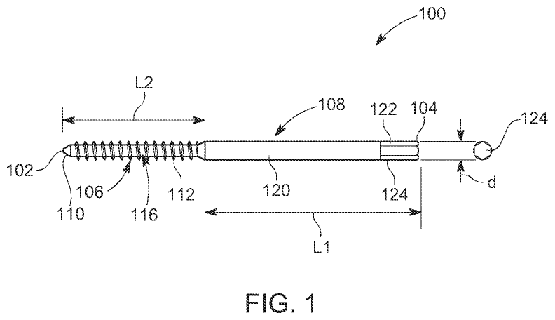

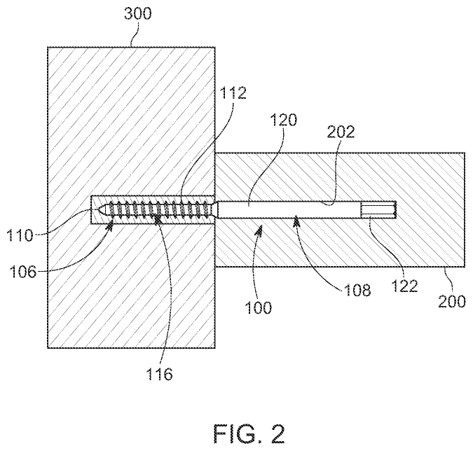

Referring to FIG. 1 and FIG. 2, a fastener 100 to facilitate a connection and a mounting of a floating shelf 200 to a wall 300, for example, a drywall, is shown. The fastener 100 may be made of steel and may include a coating of zinc or black oxide. Although, the fastener 100 made of steel is contemplated, it may be envisioned that the fastener 100 may be made of any other material known in the art and suitable for making fastener 100. Similarly, the fastener 100 may include the coating of any other material that is generally used as coating on the fasteners known in the art. For example, the coating may be an anti-rust coating or an anti-corrosion coating. As shown in FIG. 1 and FIG. 2, the fastener 100 includes a first longitudinal end 102, a second longitudinal end 104, a screw structure 106 extending from the first longitudinal end 102 towards the second longitudinal end 104, and a dowel structure 108 extending from the screw structure 106 to the second longitudinal end 104 in an axial direction of the fastener 100. As shown, the screw structure 106 includes a penetrating tip 110, and threads 112 extending from the penetrating tip 110 to the dowel structure 108. In an embodiment, the screw structure 106 may taper inwardly from the dowel structure 108 to the first longitudinal end 102. The penetrating tip 110 facilitates an insertion of the screw structure 106 inside the wall 300 as the fastener 100 is rotated in a first direction and pushed forwardly inside the wall 300. In an embodiment, the threads 112 are unified national coarse (UNC) threads and the screw structure 106 is a wood screw 116. Although, the threads 112 are contemplated to be UNC threads, it may be envisioned that any other type of threads, such as, but not limited to, ACME threads, buttress threads or any other type of threads suitable to facilitate a linear insertion of the fastener 100 inside the wall 300 in response to a rotational movement of the fastener 100 may also be utilized. In some embodiments, a pitch of the threads 112 may be selected based on a type of the wall 300, for example, a cement wall, a bricked wall, a fly-ash wall, a drywall, etc.

Further, the dowel structure 108 includes a shank 120 having a substantially cylindrical body and a head 122 arranged at the second longitudinal end 104 of the fastener 100. As shown, the shank 120 extends from the screw structure 106 to the head 122 and is devoid of any threads, and the head 122 extends from the shank 120 to the second longitudinal end 104. The dowel structure 108 is adapted to be inserted or positioned inside a hole 202, for example, a blind hole, defined into the floating shelf 200. In an embodiment, the head 122 may be a hexagonal head 124 to facilitate an engagement of the fastener 100 with a torque driver or a screw-driver to enable the insertion of the screw structure 106 inside the wall 300. Although, the head 122 is contemplated as the hexagonal head 124, the head 122 may include any other type of head known in the art and generally used for bolts or screws. For example, the head 122 may be a counter-sunk head, a phillips head, a frearson head, a slotted head, a combination head, a torx head, a square head, an allen type head, a one-way head, or any other suitable type of head known in the art. Further, the dowel structure 108 includes a length ‘L1’ which is greater than or equal to a length ‘L2’ of the screw structure 106. In an embodiment, the length ‘L1’ of the dowel structure 108 is from 3.5 inches to 5 inches and the length ‘L2’ of the screw structure 106 is from 2 inches to 2.5 inches. In some embodiments, the length ‘L1’ is 3.5 inches when the length ‘L2’ is 2 inches. In some implementations, the length ‘L1’ is 5 inches when the length ‘L2’ is 2.5 inches.

In an embodiment, the length ‘L1’ and the length ‘L2’ depends on a diameter of the dowel structure 108 or the fastener 100. For example, the length ‘L1’ and the length ‘L2’ for the fasteners 100 having diameter ¼ inches and 5/16 inches are 3.5 inches and 2 inches, respectively. Also, the length ‘L1’ and the length ‘L2’ for the fasteners 100 having diameter ⅜ inches and ½ inches is 5 inches and 2.5 inches, respectively. Further, in some embodiments, the diameter of the dowel structure 108 remains constant throughout the length ‘L1’. In an embodiment, the diameter of the dowel structure 108 or the fastener 100 is from 3/16 inches to 0.5 inches. Although, the fasteners 100 having specific diameter and associated lengths ‘L1’ and ‘L2’ is mentioned, it may be appreciated that the fasteners 100 having other possible diameter and lengths ‘L1’ and ‘L2’ are also contemplated.

A method of mounting the shelf 200 to the wall 300 using the fastener 100 is now described. For mounting the shelf 200 on the wall 300, a user partially inserts at least one fastener 100 inside the wall 300 such that the screw structure 106 extends inside the wall 300 (as shown in FIG. 2). For so doing, the user may position the penetrating tip 110 abutting the wall 300 and rotates the fastener 100 in the first direction by engaging the torque driver, for example, a torque wrench, with the head 122 of the fastener 100, and rotating/operating the torque driver. In so doing, the screw structure 106 enters inside the wall 300 and is mounted to the wall 300. Subsequently, the user engages the shelf 200 with the dowel structure 108. For so doing, the user forms the at least one hole 202 inside the shelf 200 at a suitable location. In an embodiment the hole 202 may be formed by drilling. Thereafter, the user inserts the dowel structure 108 that protrudes outwardly of the wall 300 inside the hole 202, for example, the blind hole, of the shelf 200. The dowel structure 108 is inserted inside the hole 202 such that the entire dowel structure 108 (the shank 120 and the head 122) extends inside the hole 202 and an end of the shelf 200 abuts the wall 300 (as shown in FIG. 2).

It may be appreciated that a diameter of the hole 202 is substantially equal to or slightly less than the diameter of the dowel structure 108 (i.e., the shank 120) of the fastener 100 to enable a snug fitting or interference fitting of the dowel structure 108 inside the hole 202 of the shelf 200. Also, a length of the hole 202 is equal to or greater than the length ‘L1’ to ensure an abutment of the shelf 200 with the wall 300. In some embodiments, a glue may be applied to the dowel structure 108 before inserting the dowel structure 108 inside the hole 202 to enable an adhesive engagement of the dowel structure 108 with the shelf 200. In this manner, the fastener 100 enables a floating type mounting of the shelf 200 with the wall 300 without the use of complex fastening mechanism and tools and enables a faster mounting of the shelf 200 with the wall 300. Also, the installation of the floating shelves 200 on the walls 300 using the fasteners 100 can be performed by any person and does not require a skilled person.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A fastener, comprising:
a screw structure having threads; and
a dowel structure having
a shank extending from the screw structure in an axial direction and connected to the screw structure, and
a head engaged to the shank and disposed distally from the screw structure,
wherein a length of the dowel structure is greater than or equal to a length of the screw structure.

2. The fastener of claim 1, wherein the head is a hexagonal head to facilitate an engagement of a torque driver to the fastener.

3. The fastener of claim 1, wherein the screw structure is a wood screw.

4. The fastener of claim 1, wherein the threads are unified national coarse threads.

5. The fastener of claim 1, wherein the length of the screw structure is between 2 inches to 2.5 inches.

6. The fastener of claim 5, wherein the length of the dowel structure is between 3.5 inches to 5 inches.

7. The fastener of claim 1, wherein the fastener is made of steel.

8. The fastener of claim 1, wherein a diameter of the dowel structure is between 3/16 inches to 0.5 inches.

9. A method of mounting a shelf to a wall, the method comprising:
providing a fastener, wherein the fastener includes
a screw structure having threads; and
a dowel structure having
a shank extending from the screw structure in an axial direction and connected to the screw structure, and
a head engaged to the shank and disposed distally from the screw structure,
wherein a length of the dowel structure is greater than or equal to a length of the screw structure;
inserting the screw structure inside the wall;
forming a hole inside the shelf; and
inserting the dowel structure inside the hole to engage the shelf to the wall.

10. The method of claim 9, wherein inserting the dowel structure inside the hole includes snug fitting the dowel structure inside the hole.

11. The method of claim 9, wherein the dowel structure is adhesively attached to the shelf.

12. The method of claim 9, wherein a diameter of the hole is equal to a diameter of the dowel structure.

13. The method of claim 9, wherein the head is a hexagonal head to facilitate an engagement of a torque driver to the fastener to enable the insertion of the screw structure inside the wall.

14. The method of claim 9, wherein the screw structure is a wood screw.

15. The method of claim 9, wherein the threads are unified national coarse threads.

16. The method of claim 9, wherein the length of the screw structure is between 2 inches to 2.5 inches.

17. The method of claim 9, wherein the length of the dowel structure is between 3.5 inches to 5 inches.

18. The method of claim 9, wherein a diameter of the dowel structure is between 3/16 inches to 0.5 inches.

19. A fastener, comprising:
a screw structure, wherein the screw structure is a wood screw having unified national coarse threads; and
a dowel structure having
a shank extending from the screw structure in an axial direction and connected to the screw structure, and
a hexagonal head engaged to the shank and disposed distally from the screw structure, wherein the hexagonal head facilitates an engagement of a torque driver to the fastener,
wherein a length of the dowel structure is greater than or equal to a length of the screw structure.

20. The fastener of claim 19, wherein
the length of the screw structure is between 2 inches to 2.5 inches, and
the length of the dowel structure is between 3.5 inches to 5 inches.
